(19) United States
(12) Patent Application Publication
(10) Pub. No.: US 2014/0378095 A1
(43) Pub. Date: Dec. 25, 2014

(54) USER TERMINAL, SECURITY SET SELECTION METHOD, AND USER TERMINAL PROGRAM

(71) Applicant: OPTiM Corporation, Saga-shi (JP)

(72) Inventor: Shunji SUGAYA, Tokyo (JP)

(73) Assignee: OPTiM Corporation, Saga-shi (JP)

(21) Appl. No.: 14/043,961

(22) Filed: Oct. 2, 2013

(30) Foreign Application Priority Data
Jun. 24, 2013 (JP) 2013-132100

(51) Int. Cl. H04W 12/00

(52) U.S. Cl. CPC H04W 12/00
USPC 455/410

(57) ABSTRACT

Usage scene information such as date, time, and location information acquired by a user terminal 10 is analyzed and classified as a usage scene. An appropriate security set is automatically selected from a security set list according to the usage scene that is the analysis result, and is applied to the user terminal 10.

### CROSS-REFERENCE TO RELATED APPLICATION

The present application claims priority to and the benefit of Japanese Patent Application No. 2013-132100 filed on Jun. 24, 2013, the entire contents of which are incorporated herein by reference.

### BACKGROUND

(a) Field

The present invention generally relates to a user terminal, a security set selection method, and a user terminal program for selecting an appropriate security set according to a usage scene of the user terminal

(b) Description of the Related Art

In recent years, various services have been provided to users by connecting mobile terminals connected to a public network to the Web server or the like. In particular, smart phones (i.e., high-performance mobile phones) have allowed the mobile terminals to provide advanced services that have been conventionally performed by personal computers.

Therefore, there are companies that provide employees with high-performance terminals including smartphones to improve the work efficiency. However, since the high-performance terminals have high degrees of freedom, the employees can use functions that are not related with the work, or accidentally cause adverse results such as information leakage as an unpredictable result.

Accordingly, these terminals are required to set an appropriate security according to user environment to avoid the danger without sacrificing as much as possible convenience.

For such a problem, a mobile phone for easily identifying a location where the function is restricted by location information and for preventing others from easily recognizing the location is disclosed.

In a technology disclosed in Japanese Patent Application Publication No. 2013-4990 discloses, a mobile phone has a storage unit storing an image file with location information in association with security setting information representing a content of restricting a function of the phone. The mobile phone retrieves and extracts an image file with location information in which a distance between a current location of the phone obtained by a location information obtaining unit and a location indicated by the location information satisfies a predetermined condition, and displays the extracted image file along with identification information on a display unit. According to this technology, the function is restricted by the location information and the restriction is shown by the associated image such that the location can be easily identified and others cannot easily recognize the location.

However, this technology merely sets the location where a specific function is restricted, but does not take account of a change in a security policy to which a state of the terminal or user is reflected. Therefore, there is a problem that obtainable information from the terminal cannot be fully used and the appropriate function restriction cannot be set.

### SUMMARY

An aspect of the present invention is to provide a user terminal, a security set selection method, and a user terminal program for collecting information about a usage scene from the user terminal, analyzing the usage scene from the information, and automatically selecting and applying an appropriate security set in accordance with the usage scene that is the analysis result.

A first aspect of the present invention provides a user terminal having a storage unit in which each of a plurality of security sets is stored in association with one or more usage scenes wherein each of the security sets is a combination of security parameters related to restrictions of functions. The user terminal includes a usage scene information acquisition module configured to acquire at least one of current date, current time, a location of the user terminal, or a communication status of the user terminal, as usage scene information of the user terminal, a usage scene analysis module configured to analyze a usage scene from the acquired usage scene information, a security set selection module configured to select a security set corresponding to the analyzed usage scene based on the analyzed usage scene, and a security set applying module configured to perform a function restriction based on the selected security set.

According to the first aspect of the present invention, a user terminal, which has a storage unit in which each of a plurality of security sets is stored in association with one or more usage scenes wherein each of the security sets is a combination of security parameters related to restrictions of functions, can acquire at least one of current date, current time, a location of the user terminal, or a communication status of the user terminal, as usage scene information of the user terminal, analyze a usage scene from the acquired usage scene information, select a security set corresponding to the analyzed usage scene based on the analyzed usage scene, and perform a function restriction based on the selected security set.

The first aspect of the present invention relate to the user terminal, but can be applicable to a security set selection method and a user terminal program in the same manner.

A second aspect of the present invention provides the user terminal according to the first aspect wherein the plurality of security sets stored in the storage unit are gradually arranged in increasing order of restriction.

According to a second aspect of the present invention, in the user terminal according to the first aspect, the plurality of security sets stored in the storage unit can be gradually arranged in increasing order of restriction.

A third aspect of the present invention provides the user terminal according to the first aspect or the second aspect, further including a schedule management function configured to manage plans of a user based on time series. The usage scene analysis module analyzes the usage scene with regarding a plan at a current time as a part of the usage scene information.

According to the third aspect of the present invention, the user terminal according to the first aspect or the second aspect can include a schedule management function configured to manage plans of a user based on time series, and the usage scene analysis module can analyze the usage scene with regarding a plan at a current time as a part of the usage scene information.

A fourth aspect of the present invention provides a method of selecting a security set by a user terminal having a storage unit in which each of a plurality of security sets is stored in association with one or more usage scenes wherein each of the security sets is a combination of security parameters related to restrictions of functions. The method includes acquiring at least one of current date, current time, a location of the user terminal, or a communication status of the user terminal, as usage scene information of the user terminal, analyzing a usage scene from the acquired usage scene information, selecting a security set corresponding to the analyzed usage scene based on the analyzed usage scene, and performing a function restriction based on the selected security set.

A fifth aspect of the present invention provides a program for executing a security set selection method in a user terminal having a storage unit in which each of a plurality of security sets is stored in association with one or more usage scenes wherein each of the security sets is a combination of security parameters related to restrictions of functions. The method includes acquiring at least one of current date, current time, a location of the user terminal, or a communication status of the user terminal, as usage scene information of the user terminal, analyzing a usage scene from the acquired usage scene information, selecting a security set corresponding to the analyzed usage scene based on the analyzed usage scene, and performing a function restriction based on the selected security set.

According to aspects of the present invention, a user terminal, a security set selection method, and a user terminal program for collecting information about a usage scene from the user terminal, analyzing the usage scene from the information, and automatically selecting and applying an appropriate security set in accordance with the usage scene that is the analysis result can be provided.

### BRIEF DESCRIPTION OF THE DRAWINGS

FIG. 1 is a schematic diagram showing a security set selection system 1 according to an embodiment of the present invention.

FIG. 2 is a diagram showing a relationship of each function and each function block of a user terminal 10.

FIG. 3 is a flowchart of a security set selection process executed by a user terminal 10.

FIG. 4 is a flowchart of a usage scene analysis process by executed a user terminal 10.

FIG. 5 shows an example of a schedule managed by a management function of a user terminal 10.

FIG. 6 shows an example of a screen of a user terminal 10 to which a security set is applied.

FIG. 7 shows an example of a security set list 20 stored in a storage unit of a user terminal 10.

### DETAILED DESCRIPTION

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Overview of Security Set Selection System 1

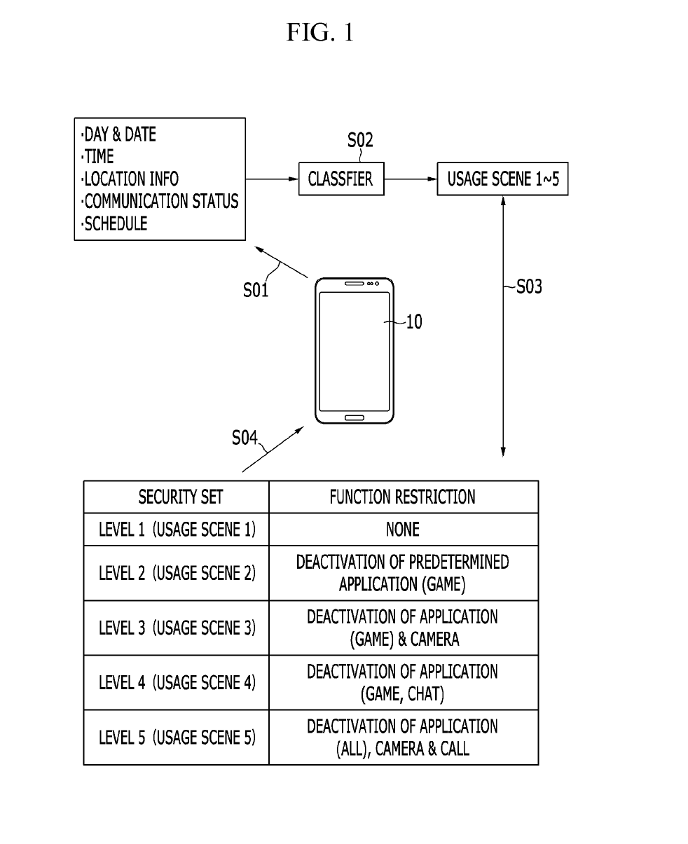

FIG. 1 is a schematic diagram showing a security set selection system 1 according to an embodiment of the present invention. An overview of a security set selection system 1 is described with reference to FIG. 1.

The security set selection system 1 includes one user terminal 10 which is an information terminal used by a user. A storage unit of the user terminal 10 stores a plurality of security sets that are described in below.

First, the user terminal 10 acquires information related to a usage scene (S01). Here, the usage scene refers to a scene (environment) in which the terminal is used, and categorizes information inside and outside the user terminal. As a specific example, the usage scene may include “usage in holiday”, “usage in business hours and in a time when the Internet is not connected at the outside” of the terminal, and the like. There is no limitation in the example of the usage scene. In an embodiment of the present invention, the usage scene may be determined in association with a security policy.

That is, since there is a security policy required in each usage scene, it is efficient to arrange each security policy in combination with a corresponding usage scene. However, since there are the usage scenes that have the same security policy but correspond to the different circumstances, the number of security policies may be different from the number of usage scenes.

Further, the information related to the usage scene is information inside and outside the user terminal which can be obtained by the user terminal. The information related to the usage scene may include date, day, time, location information, and/or the like outside the user terminal, and may include a connection status of the Internet inside the user terminal Furthermore, when the user terminal 10 has a schedule management function, a schedule may be used as the information about the usage scene with high reliability.

Next, the user terminal 10 analyzes the acquired information related usage scene (S02). The analysis is to estimate the usage scene from the acquired information, and the analysis by a classifier is shown in FIG. 1. An example of the classifier may be Bayesian classifier, a support vector machine (SVM), a decision tree, or the like, and serves to perform the estimation with high accuracy from the limited information. Even if the classifier is not used, the usage scene may be estimated by conditional branching if the condition is simple.

Then, the user terminal 10 selects a corresponding security set based on the usage scene that is the analysis result (S03). The usage scenes correspond to the security sets, respectively. Accordingly, when the usage scene is determined, the corresponding security set corresponding is uniquely determined.

Here, the security set refers to any combination of a plurality of security parameters for security parameters related to restrictions of respective functions of the user terminal 10. That is, representing a security policy as a combination of security parameters may be a security set. For example, in FIG. 1, parameters including deactivation of game applications and deactivation of a camera are stored as security parameters for a set security of level 3.

Next, the user terminal 10 applies the selected security set to itself (S04). By the above-described process, the user terminal 10 can obtain the information related usage scene, thereby automatically selecting and applying the appropriate security set. The above is an overview of the security set selection system 1.

System Configuration of Security Set Selection System 1

A security set selection system 1 includes a single user terminal 10.

Here, the user terminal 10 may be a general information terminal used by the user or an information device or an electric appliance having a function to be described below. For example, the user terminal 10 may be an electronic information appliance such as a cellular phone, a smartphone, a hybrid printer, a television, an internet device such as a router or a gateway, a computer, or a major appliance such as a refrigerator or a washing machine. Alternatively, the user terminal 10 may be an information appliance such as a telephone, a network terminal, a slate terminal, an electronic book reader, an electronic dictionary terminal, a portable music player, or a portable content recording and playback player.

Description of Each Function

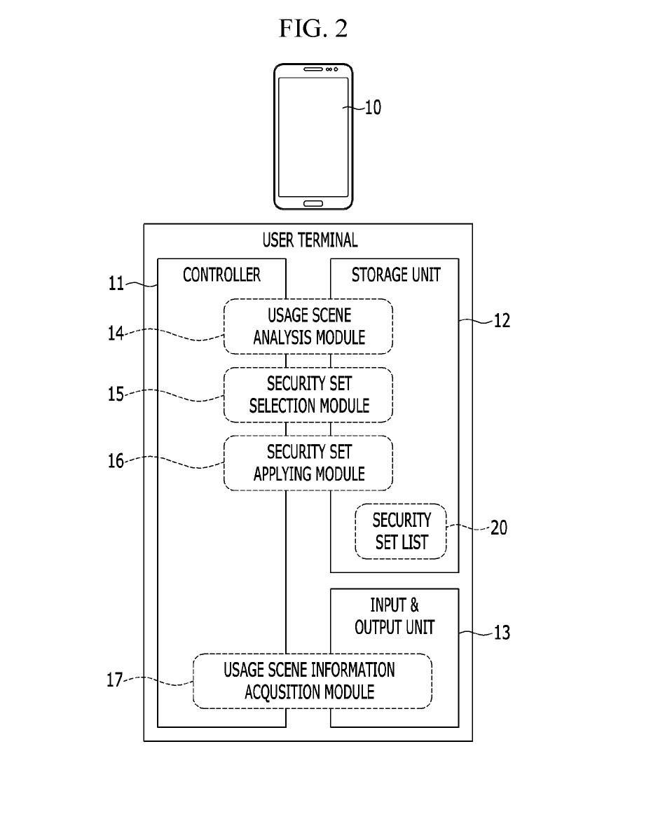

FIG. 2 is a diagram showing a relationship of each function and each function block of a user terminal 10.

The user terminal 10 includes a central processing unit (CPU), a random access memory (RAM), a read only memory (ROM) and the like as a controller 11, and includes a data storage unit according to a hard disk or a semiconductor memory as a storage unit 12. The user terminal 10 includes a device for receiving an input of external information including location information as an input and output unit 13. The user terminal 10 has a security set list 20 in the storage unit 12.

In the user terminal 10, the controller 11 reads a predetermined program, thereby realizing a usage scene analysis module 14, a security set selection module 15, and a security set applying module 16, with cooperating with the storage unit 12. Further, in the user terminal 10, the controller 11 reads a predetermined program, thereby realizing a usage scene information acquisition module 17 with cooperating with an input and output unit 13.

Set Security Selection Process

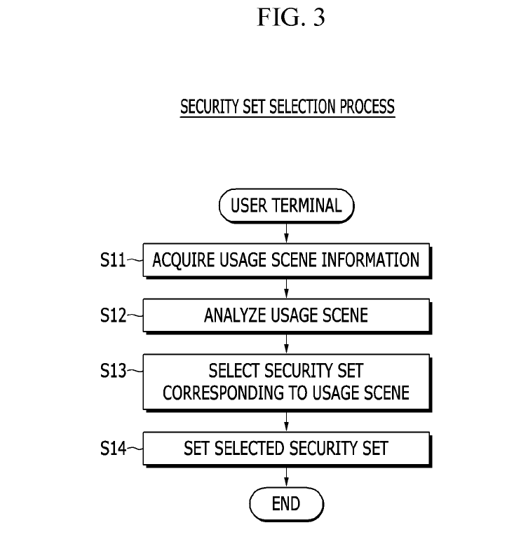

FIG. 3 is a flowchart of a security set selection process executed by a user terminal 10. Processes executed by the modules of each device described above are described in conjunction with the present process.

First, the usage scene information acquisition module 17 of the user terminal 10 acquires information related to usage scene (S11). The usage scene information acquisition module 17, as information related to usage scene, acquires day, date, and time when the user terminal 10 has a watch function, acquires location information when the user terminal 10 has a location information acquisition function, and acquires a communication status when the user terminal 10 has a communication function such as the internet regardless of information inside and outside the user terminal. Here, the need to obtain all kinds of information is not necessarily. However, accuracy in the analysis of a next usage scene may be improved as the information is increased.

Further, when the user terminal 10 has a schedule management function, schedule information may be information related usage scene with high reliability. That is, if a plan that is registered at a current time exists, the usage scene can be regarded as a content of the plan.

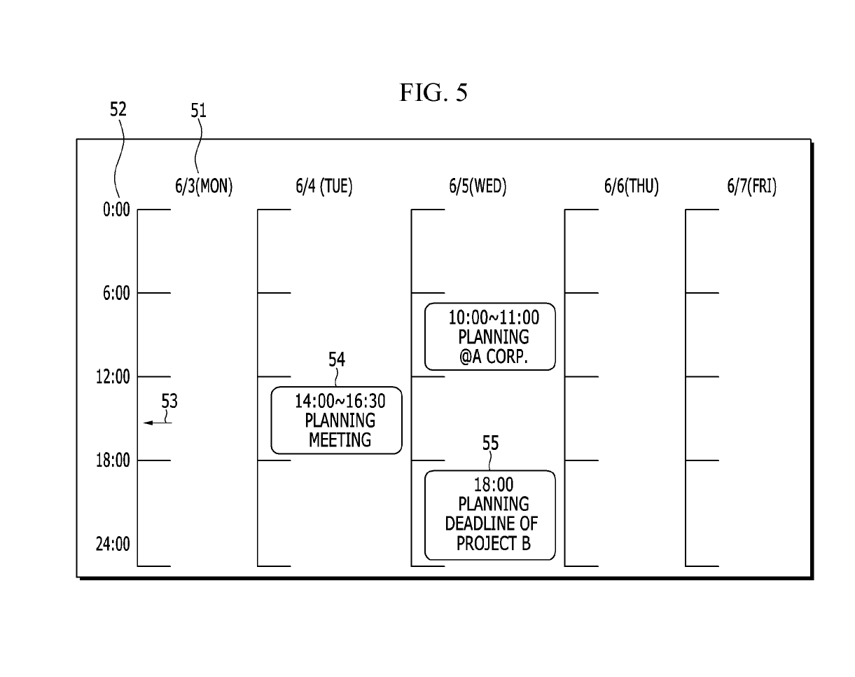

FIG. 5 shows an example of a schedule managed by a management function of a user terminal 10. In FIG. 5, a right side on a horizontal direction represents a later date for the date 51, and a lower side represents a later time for the time 52. Further, a current date and time is represented by an arrow 53. In this schedule, the date, the time and the content are managed like a plan 54. For example, when a current time is June 4, 15:00, the current usage scene is regarded as “Planning Meeting” since the current time is within the range of the plan 54. Since the content of the plan 54 includes “Meeting”, the schedule management function may apply the different background color from a plan 54 whose content does not include “Meeting” to the plan 54, thereby distinguishing the plan 54 from the plan 55. Distinguishing may be performed by a selection of the user.

Next, the usage scene analysis module 14 of the user terminal 10 analyzes the usage scene (S12). Here, the analysis refers to estimating the usage scene from the acquired information. Further, a classification of the usage scene using simple conditional branches may be exemplified as an example of a case that conditions for each usage scene are clear.

Usage Scene Analysis Process

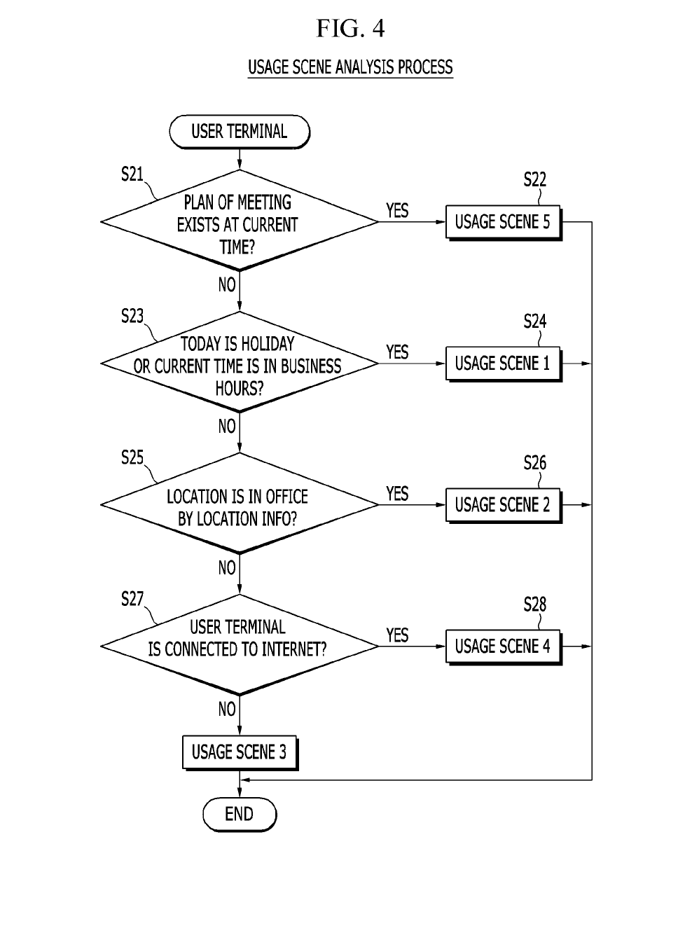

FIG. 4 is a flowchart of a usage scene analysis process by executed a user terminal 10. Processes executed by the modules of each device described above are described in conjunction with the present process.

First, the usage scene analysis module 14 determines whether plans include a meeting plan at a current time with reference to the plans stored by the schedule management function (S21). When the plans exist, determining whether the plans include the meeting may be performed by analyzing a description or a tag attached by the user. If the current plan includes the meeting plan (S21: YES), the usage scene analysis module 14 classifies a current usage scene as usage scene 5 (S22) and ends the process.

On the other hand, if the meeting plan does not exist (S21: NO), the usage scene analysis module 14 determines whether today is a holiday or whether the current time is within non-business hours (S23). The determination may be performed by comparing working days and business hours that is previously input with a current day and time acquired by the user terminal 10. If today is the holiday or the current time is within the non-business hours (S23: YES), the usage scene analysis module 14 classifies the current usage scene as usage scene 1 (S24) and ends the process.

On the other hand, if today is not the holiday and the current time is within the business hours (S23: NO), the usage scene analysis module 14 determines whether the user terminal 10 is used at the office (S25). The determination may be performed by measuring a distance between position information of the office that is previously stored and current position information according to the global positioning system (GPS). If the user terminal 10 is in the office (S25: YES), and the usage scene analysis module 14 classifies the current usage scene as a usage scene 2 (S26) and ends the process.

On the other hand, if the user terminal 10 is not in the office (S25: NO), the usage scene analysis module 14 determines whether the user terminal 10 is connected to the internet (S27). If the user terminal 10 is connected to the internet (S27: YES), and the usage scene analysis module 14 classifies the current usage scene as usage scene 4 (S28) and ends the process. If the user terminal 10 is not connected to the internet (S27: NO), and the usage scene analysis module 14 classifies the current usage scene as a usage scene 3 (S29) and ends the process.

As described above, the usage scene analysis process is provided. If the usage scene analysis cannot be sufficiently performed by a simple flowchart analysis described above, the usage scene can be analyzed by using the classifier such as the Bayesian classifier, the SVM), or the decision tree,

Referring to the security set selection process shown in FIG. 3 again, the security set selection module 15 of the user terminal 10 selects a corresponding security set based on the usage scene that is the analysis result (S13). Each of the security sets corresponds to one or more usage scenes. That is, when the usage scene is determined, the corresponding security set is uniquely determined

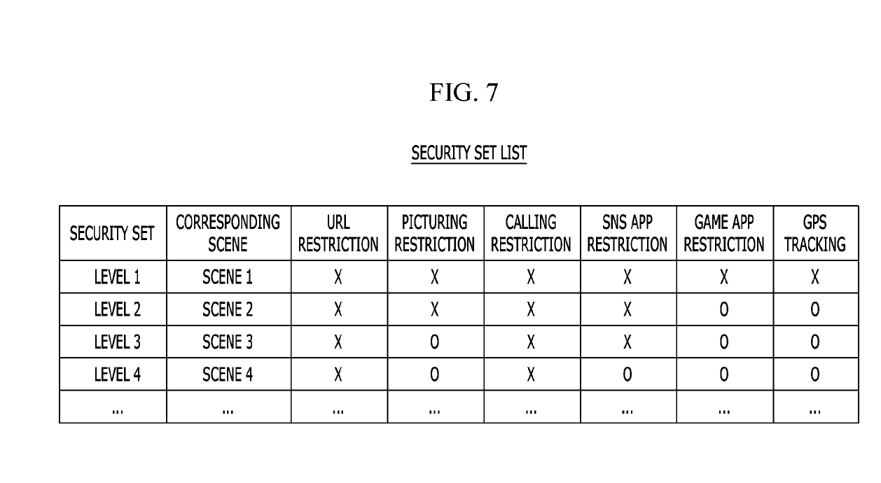

FIG. 7 shows an example of a security set list 20. For each security set, specific contents of security parameters and the corresponding scenes are recorded. For example, when the usage scene 3 is determined as the analysis result, “level 3” is selected as the corresponding security set by the security set selection module 15.

Here, the security set is a security policy that is embodied as a combination of specific values. On the other hand, in many cases, the intensity of a change in the security policy due to a change in the usage scene is uniquely determined depending on the usage scene. Therefore, if security lists are recorded in the security set list to allow their restrictions to be gradually increased, they can be efficiently described, and a probability of the security set far away from the correct content being selected can be reduced.

Next, the security set applying module 16 of the user terminal 10 applies the selected security set to the user terminal 16 (S14). An applying method depends on the user terminal 10, and may include, for example, a method using the security set as a parameter of the MDM. In this case, an embodiment of the present invention may be implemented as a function of the MDM.

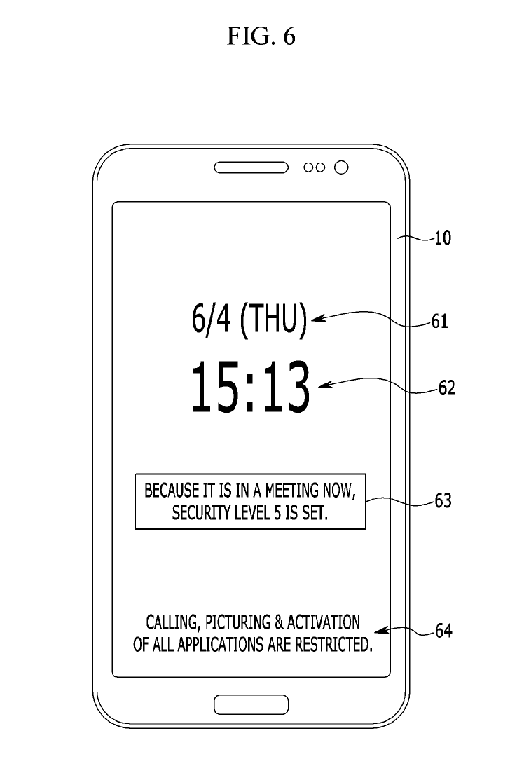

FIG. 6 shows an example of a screen of a user terminal 10 to which a security set is applied. Since a plan at a time zone indicated by date 61 and time 62 is “Planning Meeting” according to FIG. 5, the result of the usage scene classification process is “usage scene 5” and the security set of “level 5” is applied. A notification is displayed as a message 63, and details of restricted functions are also displayed.

As described above, the security set selection process is provided. According to this process, the appropriate security can be automatically set to the user terminal 10 without the user's active input of security parameters. In particular, when the functions are often restricted to constrain the general user, the automatic security setting such as this process is very effective.

The above-described means and functions are realized by reading and executing a predetermined program by a computer (including a CPU, an information processing apparatus, and various terminals). The program is recorded in a computer-readable recording medium, for example, a flexible disk, a CD (e.g., a CD-ROM or the like) and a DVD (e.g., a DVD-ROM, a DVD-RAM, or the like). In this case, the program is read from the recording medium by a computer and transmitted to an internal storage unit or an external storage unit to be stored and executed. Further, the program may be pre-stored in a storage unit (recording medium) such as a magnetic disk, an optical disk, or an optical magnetic disk and transmitted from the recording medium to a computer through a communications line.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A user terminal having a storage unit in which each of a plurality of security sets is stored in association with one or more usage scenes, each of the security sets being a combination of security parameters related to restrictions of functions, the user terminal comprising:
a usage scene information acquisition module configured to acquire at least one of current date, current time, a location of the user terminal, or a communication status of the user terminal, as usage scene information of the user terminal;
a usage scene analysis module configured to analyze a usage scene from the acquired usage scene information;
a security set selection module configured to select a security set corresponding to the analyzed usage scene based on the analyzed usage scene; and
a security set applying module configured to perform a function restriction based on the selected security set.

2. The user terminal of claim 1, wherein the plurality of security sets stored in the storage unit are gradually arranged in increasing order of restriction.

3. The user terminal of claim 2, further comprising a schedule management function configured to manage plans of a user based on time series,
wherein the usage scene analysis module analyzes the usage scene with regarding a plan at a current time as a part of the usage scene information.

4. The user terminal of claim 1, further comprising a schedule management function configured to manage plans of a user based on time series,
wherein the usage scene analysis module analyzes the usage scene with regarding a plan at a current time as a part of the usage scene information.

5. A method of selecting a security set by a user terminal having a storage unit in which each of a plurality of security sets is stored in association with one or more usage scenes, each of the security sets being a combination of security parameters related to restrictions of functions, the method comprising:
acquiring at least one of current date, current time, a location of the user terminal, or a communication status of the user terminal, as usage scene information of the user terminal;
analyzing a usage scene from the acquired usage scene information;
selecting a security set corresponding to the analyzed usage scene based on the analyzed usage scene; and
performing a function restriction based on the selected security set.

6. A program for executing a security set selection method in a user terminal having a storage unit in which each of a plurality of security sets is stored in association with one or more usage scenes, each of the security sets being a combination of security parameters related to restrictions of functions, the method comprising:
acquiring at least one of current date, current time, a location of the user terminal, or a communication status of the user terminal, as usage scene information of the user terminal;
analyzing a usage scene from the acquired usage scene information;
selecting a security set corresponding to the analyzed usage scene based on the analyzed usage scene; and
performing a function restriction based on the selected security set.
